(19) United States
(12) Patent Application Publication
(10) Pub. No.: US 2022/0251395 A1
(43) Pub. Date: Aug. 11, 2022

(54) Polydopamine + Sio2 Underlayer For Improving Diamond-Like Carbon Coating Adhesion And Durability

(71) Applicant: BOARD OF TRUSTEES OF THE UNIVERSITY OF ARKANSAS, Fayetteville, AR (US)

(72) Inventors: Dipankar Choudhury, Fayetteville, AR (US); Min Zou, Fayetteville, AR (US)

(73) Assignee: BOARD OF TRUSTEES OF THE UNIVERSITY OF ARKANSAS, Fayetteville, AR (US)

(21) Appl. No.: 17/666,517

(22) Filed: Feb. 7, 2022

Related U.S. Application Data
(60) Provisional application No. 63/146,294, filed on Feb. 5, 2021.

(51) Int. Cl. C09D 5/00; C09D 165/00; C09D 7/61; C09D 7/40; C09D 1/00

(52) U.S. Cl. CPC C09D 5/002; C09D 165/00; C08K 3/36; C09D 7/67; C09D 1/00; C09D 7/61

(57) ABSTRACT

A composite comprising: substrate having thereon an intermediate layer and a diamond-like carbon (DLC) top layer on said intermediate layer, with increased adhesion strength to DLC and other hard coatings, and which provides a buffer layer for adjusting the uneven expansion/compression behavior of DLC coatings and substrates.

### RELATED APPLICATIONS

This application claims priority to U.S. Provisional Application No. 63/146,294, filed on Feb. 5, 2021, which is incorporated herein in its entirety.

### STATEMENT REGARDING FEDERALLY SPONSORED RESEARCH & DEVELOPMENT

This invention was made with government support by the National Science Foundation under Grants CMMI-1563227 and OIA-1457888. The government has certain rights in the invention.

### INCORPORATION BY REFERENCE OF MATERIAL SUBMITTED ON A COMPACT DISC

Not applicable.

### BACKGROUND OF THE INVENTION

Diamond-like carbon (DLC) coatings provide many desirable surface properties, including high hardness, corrosion and scratch resistance, semi-transparency, low coefficient of friction (COF), and long durability. Thus, DLC is considered as one of the most attractive coatings for many applications, including computer hard drive, automotive, aeronautic, biomedical, and micromachining applications.

Despite the advantages mentioned above, DLC coatings suffer from delamination because of thermal and mechanical property mismatch between DLC coatings and the metallic substrates and the low toughness of DLC due to high internal stresses. Several approaches, including adding one or multiple underlayers, incorporating doping materials, and modifying substrate properties, have been reported in the current literature to improve adhesion strength between the DLC coatings and the substrates.

Several publications reported SiCx or a-SiCx:H as a successful interlayer for DLC coatings. Particularly, when a-SiCx:H was fabricated using a trimethylsilane [(CH₃)₃SiH] (TMS) precursor at 300° C. and higher, it glued DLC to the steel substrate very firmly. Very recently, Kasiorowski (2020) studied DLC with three different underlayers, including the SiCx layer on nitrided and non-nitrided steel substrates. The nitrided steel substrates showed a substantial improvement in the adhesion strength of DLC coatings compared to the non-nitrided steel substrates. Furthermore, nitrided steel substrates also had superiority in reducing the crack propagation of SiCx/DLC. DLC coating with a SiCx or a-SiCx:H underlayer is referred to as TMS/DLC.

Interestingly, most of the reported underlayers for DLC coating, including SiCx or a-SiCx:H, are mainly metallic or ceramic. Although polydopamine (PDA) has a unique sticking ability that has been used to adhere to other coatings, no research was found utilizing PDA as an underlayer for DLC coatings.

PDA is a biomimetic thin film and has the capability of sticking to many materials. PDA has been used as an adhesive layer for polymeric coatings, such as polytetrafluoroethylene (PTFE), to adhere to a substrate. It is worth noting that PTFE is a chemically inert material, and its adhesive strength with metallic substrates is weak. Thus, early delamination of single-layer PTFE coating with a metallic substrate is common. Remarkably, PDA/PTFE coatings had significantly improved coating adhesive strengths and wear lives compared to PTFE coatings without the PDA underlayer. Very recently, Choudhury et al. (2020) showed the durability of PDA/PTFE thin films was extended 3.6 times further by adding only 2.0 wt % of Ag nanoparticles in the PDA layer. The improvement was partially attributed to the increased underlayer roughness that provided mechanical interlocking.

### BRIEF SUMMARY OF THE INVENTION

One embodiment of the present invention concerns PDA+SiO₂ nanoparticle composite underlayer with increased adhesion strength to DLC and other hard coatings. In addition, the PDA+SiO₂ nanoparticle composite thin film provides a buffer layer for adjusting the uneven expansion/compression behavior of DLC coatings and substrates.

In other embodiments, the present invention pertains to the use of a PDA+SiO₂ nanoparticle composite as underlayers for DLC coating (PDA+SiO₂/DLC) to reduce coating delamination and crack propagation. Its tribological performance is much better than DLC without an underlayer (DLC only), with a PDA underlayer (PDA/DLC), and with a trimethylsilane [(CH₃)₃SiH] underlayer (TMS/DLC). It is noted that TMS/DLC was used for comparison because it is widely used to prevent DLC delamination and improve coating durability.

In other embodiments, the present invention concerns PDA+SiO₂/DLC with increased critical loads for initial crack propagation, initial delamination, and global delamination compared to DLC without an underlayer (DLC only), with a PDA underlayer (PDA/DLC), and with a TMS underlayer (TMS/DLC). The improvements are attributed to the adhesive nature of the composite layer, the mechanical interlocking through the nano roughness provided by the SiO₂ nanoparticles, and the elasticity of the PDA to tolerate the mismatch between the substrate and DLC top layer. 500-cycle linear reciprocating wear tests revealed a 2.5 times reduction in the cross-sectional area of the wear tracks and 40 times smaller crack sizes of PDA+SiO₂/DLC compared to those of the TMS/DLC. Thus, the PDA+SiO₂ underlayer can be used for DLC coatings for preventing cracks and delamination and providing longer durability to DLC coatings.

In other embodiments, the present invention provides a system, device, and method that provide a substrate coated with PDA or PDA+SiO₂ nanoparticle composite underlayer and a DLC top layer.

In other embodiments, the present invention provides a system, device, and method that concern a substrate coated with PDA and a nanoparticle composite underlayer.

In other embodiments, the present invention provides a system, device, and method that provide a substrate, such as stainless steel and many other materials, e.g., metals such as cast iron, carbon steels, or intermetallic materials, such as 60NiTi, Nitinol, and polymers, coated with PDA and one or more nanoparticles and a DLC top layer. The nanoparticles may be Al₂O₃, ZrO₂, TiO₂, N—TiO₂—C, Fe₃O₄, MoS₂, WS₂, diamond, graphite, Ag, Au, Cu, Ta, and combinations thereof. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1, includes cross-sectional views of a substrate, specifically, FIG. 1(a) is a cross-sectional view of a substrate.

FIG. 1, includes cross-sectional views of a substrate, specifically, FIG. 1(b) is a cross-sectional view of a substrate coated with PDA and SiO₂ nanoparticle composite coating.

FIG. 1, includes cross-sectional views of a substrate, specifically, FIG. 1(c) is a cross-sectional view of a substrate with PDA and SiO₂ nanoparticle composite coating, and then a DLC coating (not to scale).

FIG. 2 shows the average and root mean square surface roughness of DLC coated samples measured from 20 μm×20 μm AFM images.

FIG. 3 shows a comparison of critical loads Lc1 (initial crack propagation), Lc2 (Initial delamination), and Lc3 (Global domination) among the DLC coated samples with various underlayers.

FIG. 4 shows a comparison of surface cracks and delamination within the final part of scratch wear tracks between TMS/DLC and PDA+SiO₂/DLC.

FIG. 5 shows a comparison of the coefficient of friction profiles among DLCs with various underlayers.

FIG. 6 shows a comparison wear track on DLCs and transfer film on counterface Si₃N₄ balls after 500 cycles.

FIG. 7 shows a comparison of the cross-sectional areas of wear tracks after 500 cycles among DLCs with various underlayers.

FIG. 8 shows a comparison of the average area of cracks in the wear tracks after 500 cycles between TMS/DLC and PDA+SiO₂/DLC.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

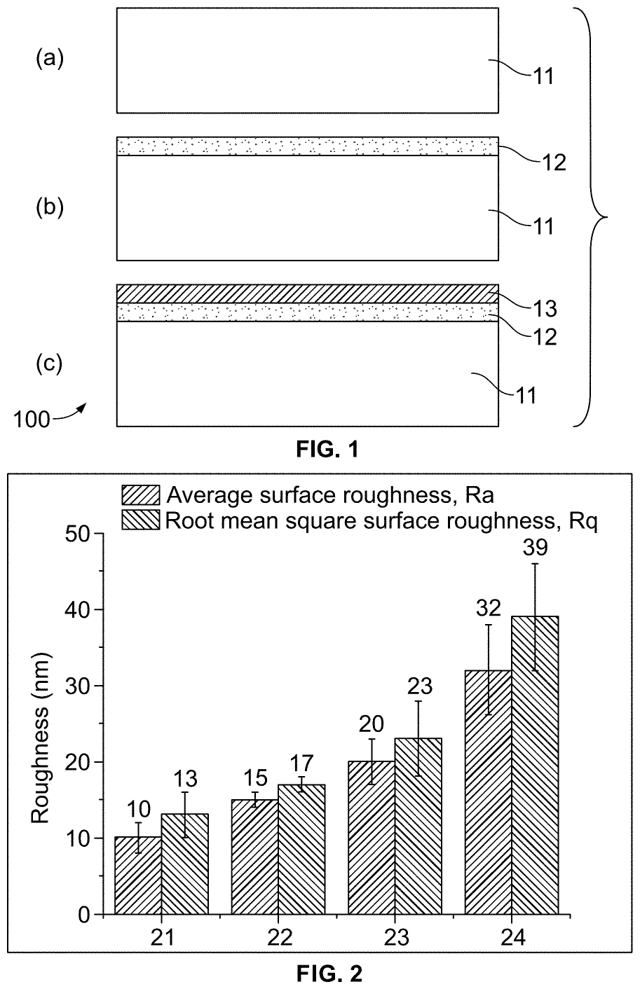

In certain embodiments, the present invention provides PDA and PDA+SiO₂ underlayers that may be deposited on substrates such as stainless steel (SS). In one preferred embodiment, a digital rocking bath of 1.21 gm/L Tris(hydroxymethyl)aminomethane was added to 60° C. deionized water to make an ideal buffer solution for polymerizing dopamine hydrochloride (DA) into PDA. While the water-based buffer solution temperature was kept at 60° C., the rocking bath was rocked at 20 rpm with a 7° rocking angle. 13.33 mL/L of Colloidal silica dispersion (SiO₂, Nissan Chemicals ST-PS-M) was added to the buffer solution after 5 min following the addition of 2 gm/L of DA, in order to incorporate SiO₂ nanoparticles in the PDA underlayer. The polymerization process continued for another 40 min. This procedure provides a mechanically robust adhesive layer. Trimethylsilane [(CH₃)₃SiH] was deposited using a plasma immersion ion deposition (PIID) process on SS. A 300 nm thin DLC was then fabricated on SS, SS/TMS, SS/PDA, and SS/PDA+SiO₂. The structure of the DLC coating is illustrated in FIG. 1A-1C.

FIG. 1A shows a substrate (11) which may be a metal, metallic compound, ceramic, or polymer and many other materials, e.g., metals such as cast iron, carbon steels, or intermetallic materials, such as 60NiTi, Nitinol, and polymers. In one embodiment, the substrate is stainless steel (SS) with an average surface roughness of 26±2 nm. FIG. 1B shows a cross-sectional views of substrate (11), coated with PDA or PDA+SiO₂ nanoparticle composite coating (12). The average roughness of PDA coated SS was 50±5 nm, and the average roughness of PDA+SiO₂ coated SS was 60±7 nm.

FIG. 1C shows a preferred embodiment of the present invention. This embodiment concerns a composite 100 comprised of substrate (11) coated with TMS or PDA or PDA+SiO₂ nanoparticle composite underlayer (12) and a DLC top layer (13).

In other embodiments, the present invention provides a substrate coated with TMS or PDA or PDA+SiO₂ nanoparticle composite underlayer and a DLC top layer.

In other embodiments, nanoparticles such as Al₂O₃, ZrO₂, TiO₂, N—TiO₂—C, Fe₃O₄, MoS₂, WS₂, diamond, graphite, Ag, Au, Cu, Ta, and combinations thereof may be used within the intermediate layer (12). In yet other embodiments, nanoparticles may be added between the intermediate layer and the DLC top layer

In yet other embodiments, nanoparticles such as SiO₂, Al₂O₃, ZrO₂, TiO₂, N—TiO₂—C, Fe₃O₄, MoS₂, WS₂, diamond, graphite, Ag, Au, Cu, Ta, and combinations thereof may be used between the intermediate layer and the DLC top layer (13).

The average and root mean square surface roughness of DLC-coated samples measured from 20 μm×20 μm images obtained by atomic force microscope (AFM) are shown in FIG. 2. The average surface roughness of PDA/DLC (23) and PDA+SiO₂/DLC (24) were 33.3% and 113.3% higher than the TMS/DLC (22), respectively. Similarly, the root mean square surface roughness of PDA/DLC and PDA+SiO₂/DLC were 35.3% and 129.4% higher than the TMS/DLC, respectively.

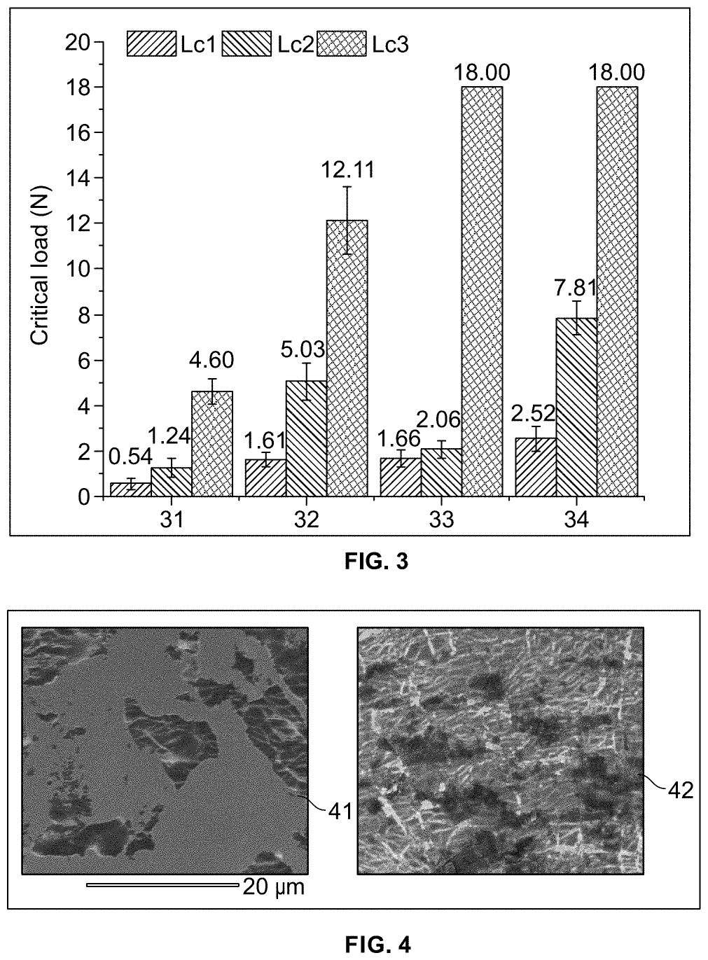

Scratch and coating wear tests were carried out using a Bruker Tribometer (UMT TriboLab, Bruker, USA). The objectives of the scratch tests were to determine three critical loads for a) lateral cracks (Lc1), b) initial delamination (Lc2), and c) global delamination (Lc3). A linearly increased normal load from 0.5 to 18 N was applied in the scratch tests using a 400 μm diameter diamond coated tip. The scratch length was 15 mm, and the speed was 0.15 mm/s. The average critical loads for Lc1, Lc2, and Lc3 are shown in FIG. 3. The highest average Lc1 was 2.52 N for the PDA+SiO₂/DLC (34), which was 4.66 and 1.57 times higher than those for the DLC only (31) and the TMS/DLC (32), respectively. More importantly, the size and number of cracks were significantly smaller and fewer compared to those of the TMS/DLC. Similarly, the highest average Lc2 was 7.81 N for the PDA+SiO₂/DLC (34), which was 6.30 and 1.55 times higher than those for the DLC only (31) and the TMS/DLC (32), respectively. Finally, there was no global delamination for the PDA/DLC (33) and PDA+SiO₂/DLC (34) at 18 N, whereas the Lc3 for the DLC (31) and TMS/DLC (32) were 4.60 N and 12.2 N, respectively.

FIG. 4 shows the comparison of wear tracks for the TMS/DLC (41) and PDA+SiO₂/DLC (42) at 17.5-18 N load range during the scratch test. Most of the TMS/DLC (41) was delaminated, whereas the PDA+SiO₂/DLC (42) was without any global delamination; however, it suffered from a few microcracks and local delamination.

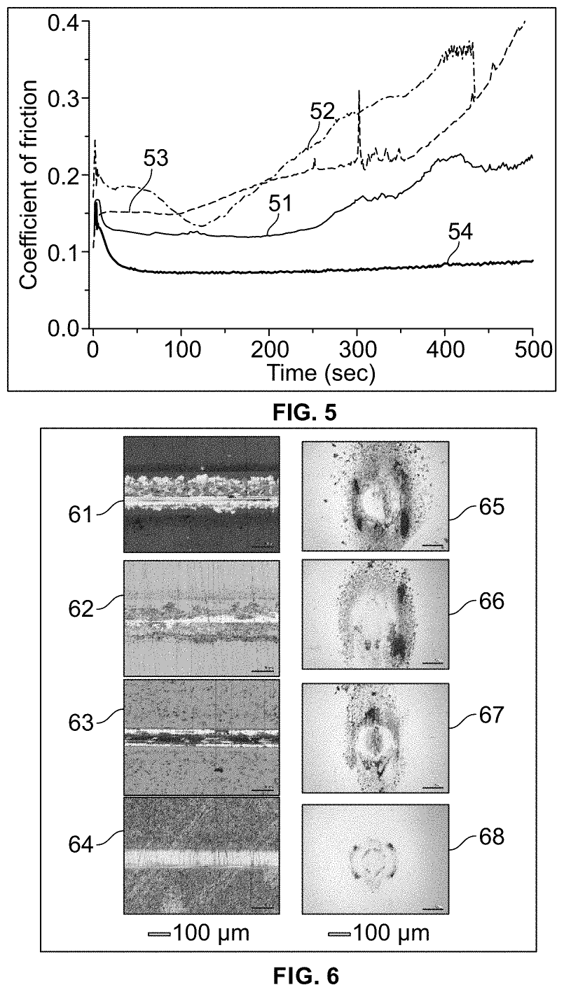

Linear reciprocating wear tests were performed for 500 cycles to determine the wear rate and wear mechanism. The average normal load was 2 N, speed was 1 mm/sec, whereas the counterface was 6.35 mm diameter Si₃N₄ balls. The comparison of the COF profiles over time among DLCs with various underlayers is shown in FIG. 5. The COF of all DLC coatings had a transition period from high to low at the beginning. However, the COF of TMS/DLC (52) showed a rapid increase after 123 cycles, whereas the DLC only (51) had a steady low COF for 250 cycles before it increased, most likely facilitated by the transfer film. The COF of PDA/DLC (53) had a slight increase at 105 cycles and then increased sharply at 360 cycles. Remarkably, the COF of PDA+SiO₂/DLC (54) remained low throughout the test after the initial drop. The DLC only (51) coating showed the second-lowest COF due to the coating delaminate early on, as shown in FIG. 6 (61), and the loose particles generated reduced the resistance to the counterface movement. The PDA+SiO₂ (54) coatings had larger and harder textures than the PDA/DLC coating due to the addition of SiO₂ NPs, which resulted in less real area of contact and thus less friction.

The wear tracks in the DLC coatings also supported the COF profiles, which are shown in FIG. 6. The DLC only (61) coating was almost entirely delaminated and had a clear sign of plowing into the SS substrate. The associated ball (65) was worn and had transfer film and loose DLC particles. The TMS/DLC (62) and PDA/DLC (63) coatings were also severely damaged as a significant portion of the coatings were delaminated with micro cracks. The counterface balls for the TMS/DLC (66) and PDA/DLC (67) had transfer films and loose DLC particles, but none of them was worn. In contrast, the PDA+SiO₂/DLC (64) coating did not have any delamination. The coating was plastically deformed, and most of its roughness peaks were worn out. The associated counterface ball (68) had transfer film and fewer number of loose DLC particles.

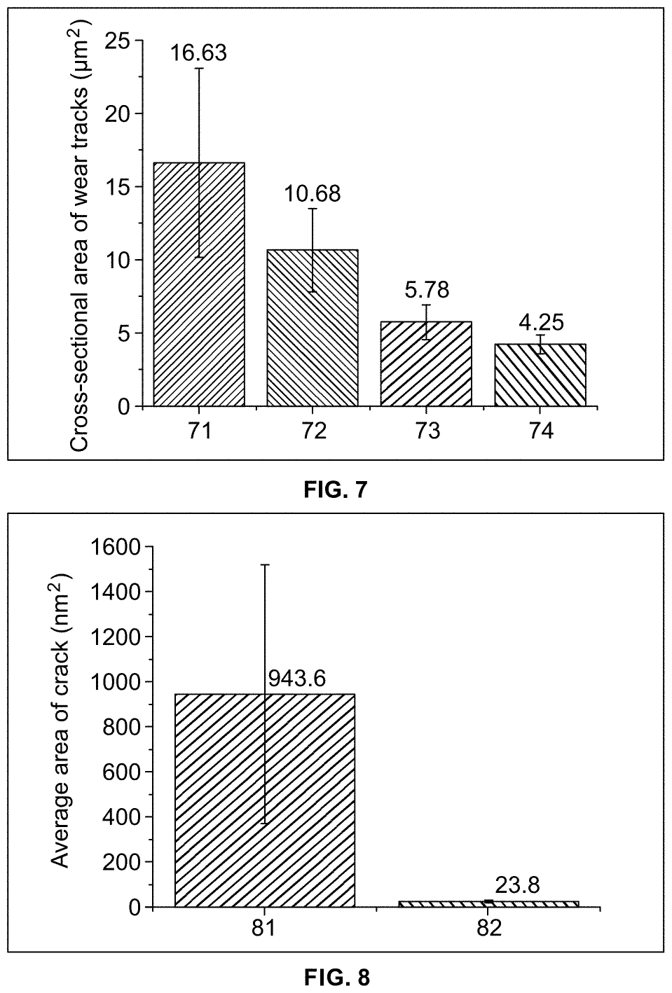

FIG. 7 shows a comparison of the average cross-sectional area of wear tracks for the DLC only (71), TMS/DLC (72), PDA/DLC (73), and PDA+SiO₂/DLC (74). The average cross-sectional area of the PDA+SiO₂/DLC (74) was 3.91 and 2.51 times smaller than that of the DLC only (71) and TMS/DLC (72), respectively.

Scanning electron microscope images of the wear tracks of the TMS/DLC and PDA+SiO₂/DLC that went through 500 cycles of wear test were analyzed to determine the size of the cracks within the wear tracks. The cracks of the PDA+SiO₂/DLC were significantly smaller than that of the TMS/DLC. As shown in FIG. 8, the average size of the micro-cracks for the PDA+SiO₂/DLC (82) was 23.8 nm², which was 40 times smaller than the microcracks of the TMS/DLC of 943.6 nm² (81).

The AFM images of the surfaces of the wear tracks after tested for various cycles were inspected to understand the wear mechanisms better. While the wear mechanisms of the TMS/DLC involved initial detachment, cracking, and delamination, those of the PDA+SiO₂/DLC only went through the worn of roughness peaks and permanent deformation. The behavior of the PDA+SiO₂/DLC indicated its superior strength in preventing initial detachment, cracking, and delamination. The nanoscale roughness and the toughness and adhesiveness of PDA+SiO₂ underlayer played an essential role in achieving these outstanding performances of PDA+SiO₂/DLC coatings.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A composite comprising: substrate having thereon an intermediate layer and a diamond-like carbon (DLC) top layer on said intermediate layer.

2. The composite of claim 1 wherein said intermediate layer is polydopamine (PDA).

3. The composite of claim 1 wherein said intermediate layer is a PDA+SiO₂ nanoparticle composite coating.

4. The composite of claim 2 wherein said substrate is a metal.

5. The composite of claim 2 wherein said substrate is a metallic compound.

6. The composite of claim 2 wherein said substrate is stainless steel.

7. The composite of claim 3 wherein said substrate is a metal.

8. The composite of claim 3 wherein said substrate is a metallic compound.

9. The composite of claim 3 wherein said substrate is stainless steel.

10. The composite of claim 6 wherein an average roughness of PDA coated stainless steel was 50±5 nm.

11. The composite of claim 10 wherein an average roughness of PDA+SiO₂ coated stainless steel was 60±7 nm.

12. The composite of claim 1 further including nanoparticles between said intermediate layer and said DLC top layer.

13. The composite of claim 12 wherein said nanoparticles are from the group comprising: Al2O3, ZrO2, TiO2, N-TiO2-C, Fe3O4, MoS2, WS2, diamond, graphite, Ag, Au, Cu, Ta, and combinations thereof.

14. The composite of claim 1 further including nanoparticles within said intermediate layer and said DLC top layer.

15. The composite of claim 14 wherein said nanoparticles are from the group comprising: Al2O3, ZrO2, TiO2, N-TiO2-C, Fe3O4, MoS2, WS2, diamond, graphite, Ag, Au, Cu, Ta, and combinations thereof.

16. The composite of claim 2 wherein said substrate is a ceramic.

17. The composite of claim 2 wherein said substrate is a polymer.
